(19) United States
(12) Patent Application Publication
(10) Pub. No.: US 2024/0362564 A1
(43) Pub. Date: Oct. 31, 2024

(54) SYSTEM AND METHOD FOR THIRD PARTY CONTINUOUS MONITORING

(71) Applicant: JPMorgan Chase Bank, N.A., New York, NY (US)

(72) Inventors: Chandrashekar D KASIBHATTA, Columbus, OH (US); Stephanie SHARP, Dublin, OH (US); Parveer K SINGH, New York, NY (US)

(73) Assignee: JPMorgan Chase Bank, N.A., New York, NY (US)

(21) Appl. No.: 18/643,384

(22) Filed: Apr. 23, 2024

Related U.S. Application Data
(60) Provisional application No. 63/462,422, filed on Apr. 27, 2023.

(51) Int. Cl. G06Q 10/0635

(52) U.S. Cl. CPC G06Q 10/0635

(57) ABSTRACT

Various methods, apparatuses/systems, and media for proactive third party risk monitoring and management are disclosed. A processor identifies base criteria that is already known data about third party suppliers who provide services to an organization; runs the base criteria continuously according to a configurable time window to identify suppliers that meet a certain set of the base criteria; implements a control assessment process to curate triggers data, that are not yet validated, received from external sources in addition to the base criteria; automatically matches the triggers data with corresponding scenario which is a predefined or preconfigured combination of base criteria and trigger criteria; implements a validation process to identify critical threat associated with the particular supplier by eliminating false positives from the match; and automatically assigns, in response to a positive validation result, a priority to the particular supplier for continuous risk monitoring and management to eliminate or remediate the identified critical threat.

### CROSS-REFERENCE TO RELATED APPLICATIONS

This application claims the benefit of priority from U.S. Provisional Patent Application No. 63/462,422, filed Apr. 27, 2023, which is herein incorporated by reference in its entirety.

### TECHNICAL FIELD

This disclosure generally relates to third party risk management, and, more particularly, to methods and apparatuses for implementing a platform, language, cloud, and database agnostic third party continuous monitoring module configured to continuously monitor services provided by third party suppliers for identifying all types of risks associated with the third party services and provide real time updates and proactively trigger alerts when risks are detected.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Currently, there are no known framework or tools which may overlay risk posed by the third party with the required insights of overlaying existing risk on top of event based risk. Some conventional tools may have mature processes to manage supplier risk, but they are typically being managed independently leading to escalation of risk. In addition, conventional program and process structure may not provide an opportunity to proactively mitigate risks associated with supplier, which may lead to potential disruption of services. Moreover, conventional tools fail to provide real time updates and fail to proactively trigger alerts when risks associated with third party suppliers are detected.

Thus, there is a need for an advanced tool that can efficiently address these conventional shortcomings associated with third party risk management.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic third party continuous monitoring module configured to continuously monitor services provided by third party suppliers (or simply, suppliers) for identifying all types of risks associated with the third party services and provide real time updates and proactively trigger alerts when risks associated with the third party services are detected, but the disclosure is not limited thereto. According to exemplary embodiments, an objective of the methodology implemented by the third party continuous monitoring module is to identify risks (triggers/events) across different risks stripes associated with suppliers, but the disclosure is not limited thereto.

For example, the present disclosure, through one or more of its various aspects, embodiments, and/or specific features or sub-components, provides, among other features, various systems, servers, devices, methods, media, programs, and platforms for implementing a platform, language, cloud, and database agnostic third party continuous monitoring module configured to enable proactive third-party risk management by quickly turning supplier data and knowledge of business impact into intelligence and actionable insights thereby resulting the following benefits: understanding where the third party suppliers are most vulnerable; leveraging existing risk attributes within an organization and overlaying it with known external threats to perform impact assessment or validation and proactively remediating or mitigating outsourcing risks; facilitating supplier or partner outreach to inform, track and remediate supplier deficiencies; having an on-demand repository of key supplier risk attributes, including known deficiencies; developing an efficient, sustainable outreach or partner engagement model, etc., but the disclosure is not limited thereto.

According to exemplary embodiments, a method for proactive third party risk monitoring and management by utilizing one or more processors along with allocated memory is disclosed. The method may include: identifying base criteria that is already known data about third party suppliers who provide services to an organization; running the base criteria continuously according to a configurable time window to identify suppliers that meet a certain set of the base criteria; identifying or mapping triggers from curated sources (externally sourced or news based platforms) to curate triggers data, that are not yet validated, received from external sources in addition to the base criteria; automatically matching the triggers data with corresponding scenario which is a predefined or preconfigured combination of the base criteria and trigger criteria; defining risk thresholds for each of the base criteria and the trigger criteria, wherein breaching this combined combination is treated as a positive match for displaying to an analyst for prioritization; implementing a validation process to identify critical threat associated with the particular supplier by eliminating false positives from the match; and automatically assigning, in response to a positive validation result, a priority to the particular supplier for continuous risk monitoring and management to eliminate or remediate the identified critical threat.

According to exemplary embodiments, the method may further include: automatically assigning a priority to the particular supplier for risk monitoring and management based on a corresponding degree of match, wherein multiple triggers match elevates the risk accordingly in a manner such that triggers match for medium priority is greater than the triggers match for low priority, triggers match for high priority is greater than the triggers match for medium priority, and triggers match for critical priority is greater than the triggers match for high priority.

According to exemplary embodiments, the method may further include: collecting the known data about third party suppliers and storing internally during onboarding of the suppliers to the organization in outsourcing such services.

According to exemplary embodiments, the method may further include: continuously monitoring the identified suppliers for risk management and mitigation.

According to exemplary embodiments, the method may further include: displaying onto a monitor, utilized by an analyst, preset matches for each risk category; overlaying the base criteria with predetermined additional triggers or selecting new triggers based on current industry risk factors.

According to exemplary embodiments, in implementing the validation process, the method may further include: assigning a corresponding subject matter expert, based on loading indicators of risk and matched attributes, for manually validating the identified critical threat and subsequent case creation.

According to exemplary embodiments, in implementing the validation process, the method may further include: implementing an artificial intelligence or rules engine to automatically validate the identified critical threat and subsequent case creation.

According to exemplary embodiments, the method may further include: implementing, by the artificial intelligence or rules engine, a machine learning based predictive analytics modeling technique where a machine learning model identifies, matches patterns, and prioritizes suppliers with higher degree or likelihood of risk threshold breach over a future timeline.

According to exemplary embodiments, the method may further include: generating, by the machine learning model, potential future scenario combinations based on outputs of rules engine.

According to exemplary embodiments, a system for proactive third party risk monitoring and management is disclosed. The system may include: a processor; and a memory operatively connected to the processor via a communication interface, the memory storing computer readable instructions, when executed, may cause the processor to: identify base criteria that is already known data about third party suppliers who provide services to an organization; run the base criteria continuously according to a configurable time window to identify suppliers that meet a certain set of the base criteria; identify or map triggers from curated sources (externally sourced or news based platforms) to curate triggers data, that are not yet validated, received from external sources in addition to the base criteria; automatically match the triggers data with corresponding scenario which is a predefined or preconfigured combination of the base criteria and trigger criteria; define risk thresholds for each of the base criteria and the trigger criteria, wherein breaching this combined combination is treated as a positive match for displaying to an analyst for prioritization; implement a validation process to identify critical threat associated with the particular supplier by eliminating false positives from the match; and automatically assign, in response to a positive validation result, a priority to the particular supplier for continuous risk monitoring and management to eliminate or remediate the identified critical threat.

According to exemplary embodiments, the processor may be further configured to: automatically assign a priority to the particular supplier for risk monitoring and management based on a corresponding degree of match, wherein multiple triggers match elevates the risk accordingly in a manner such that triggers match for medium priority is greater than the triggers match for low priority, triggers match for high priority is greater than the triggers match for medium priority, and triggers match for critical priority is greater than the triggers match for high priority.

According to exemplary embodiments, the processor may be further configured to: collect the known data about third party suppliers and store internally during onboarding of the suppliers to the organization in outsourcing such services.

According to exemplary embodiments, the processor may be further configured to: continuously monitor the identified suppliers for risk management and mitigation.

According to exemplary embodiments, the processor may be further configured to: display onto a monitor, utilized by an analyst, preset matches for each risk category; overlay the base criteria with predetermined additional triggers or select new triggers based on current industry risk factors.

According to exemplary embodiments, in implementing the validation process, the processor may be further configured to: assign a corresponding subject matter expert, based on loading indicators of risk and matched attributes, for manually validating the identified critical threat and subsequent case creation.

According to exemplary embodiments, in implementing the validation process, the processor may be further configured to: implement an artificial intelligence or rules engine to automatically validate the identified critical threat and subsequent case creation.

According to exemplary embodiments, the processor may be further configured to: implement, by the artificial intelligence or rules engine, a machine learning based predictive analytics modeling technique where a machine learning model identifies, matches patterns, and prioritizes suppliers with higher degree or likelihood of risk threshold breach over a future timeline.

According to exemplary embodiments, the processor may be further configured to: generate, by the machine learning model, potential future scenario combinations based on outputs of rules engine.

According to exemplary embodiments, a non-transitory computer readable medium configured to store instructions for proactive third party risk monitoring and management is disclosed. The instructions, when executed, may cause a processor to perform the following: identifying base criteria that is already known data about third party suppliers who provide services to an organization; running the base criteria continuously according to a configurable time window to identify suppliers that meet a certain set of the base criteria; identifying or mapping triggers from curated sources to curate triggers data, that are not yet validated, received from external sources in addition to the base criteria; automatically matching the triggers data with corresponding scenario which is a predefined or preconfigured combination of the base criteria and trigger criteria; defining risk thresholds for each of the base criteria and the trigger criteria, wherein breaching this combined combination is treated as a positive match for displaying to an analyst for prioritization; implementing a validation process to identify critical threat associated with the particular supplier by eliminating false positives from the match; and automatically assigning, in response to a positive validation result, a priority to the particular supplier for continuous risk monitoring and management to eliminate or remediate the identified critical threat.

According to exemplary embodiments, the instructions, when executed, may cause the processor to further perform the following: automatically assigning a priority to the particular supplier for risk monitoring and management based on a corresponding degree of match, wherein multiple triggers match elevates the risk accordingly in a manner such that triggers match for medium priority is greater than the triggers match for low priority, triggers match for high priority is greater than the triggers match for medium priority, and triggers match for critical priority is greater than the triggers match for high priority.

According to exemplary embodiments, the instructions, when executed, may cause the processor to further perform the following: collecting the known data about third party suppliers and storing internally during onboarding of the suppliers to the organization in outsourcing such services.

According to exemplary embodiments, the instructions, when executed, may cause the processor to further perform the following: continuously monitoring the identified suppliers for risk management and mitigation.

According to exemplary embodiments, the instructions, when executed, may cause the processor to further perform the following: displaying onto a monitor, utilized by an analyst, preset matches for each risk category; overlaying the base criteria with predetermined additional triggers or selecting new triggers based on current industry risk factors.

According to exemplary embodiments, in implementing the validation process, the instructions, when executed, may cause the processor to further perform the following: assigning a corresponding subject matter expert, based on loading indicators of risk and matched attributes, for manually validating the identified critical threat and subsequent case creation.

According to exemplary embodiments, in implementing the validation process, the instructions, when executed, may cause the processor to further perform the following: implementing an artificial intelligence or rules engine to automatically validate the identified critical threat and subsequent case creation.

According to exemplary embodiments, the instructions, when executed, may cause the processor to further perform the following: implementing, by the rules engine, a machine learning based predictive analytics modeling technique where a machine learning model identifies, matches patterns, and prioritizes suppliers with higher degree or likelihood of risk threshold breach over a future timeline.

According to exemplary embodiments, the instructions, when executed, may cause the processor to further perform the following: generating, by the machine learning model, potential future scenario combinations based on outputs of rules engine.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic third party continuous monitoring module configured for proactive third party risk monitoring and management in accordance with an exemplary embodiment.

FIG. 2 illustrates an exemplary diagram of a network environment with a platform, language, database, and cloud agnostic third party continuous monitoring device in accordance with an exemplary embodiment.

FIG. 3 illustrates a system diagram for implementing a platform, language, database, and cloud agnostic third party continuous monitoring device having a platform, language, database, and cloud agnostic third party continuous monitoring module in accordance with an exemplary embodiment.

FIG. 4 illustrates a system diagram for implementing a platform, language, database, and cloud agnostic third party continuous monitoring module of FIG. 3 in accordance with an exemplary embodiment.

FIG. 5 illustrates an exemplary architecture for trigger criteria mapping, matching, and prioritization as implemented by the platform, language, database, and cloud agnostic third party continuous monitoring module of FIG. 4 in accordance with an exemplary embodiment.

FIG. 6 illustrates an exemplary scenario model sample as implemented by the platform, language, database, and cloud agnostic third party continuous monitoring module of FIG. 4 in accordance with an exemplary embodiment.

FIG. 7 illustrates an exemplary flow chart of a process for machine learning based predictive analytics models for matching and prioritization as implemented by the platform, language, database, and cloud agnostic third party continuous monitoring module of FIG. 4 in accordance with an exemplary embodiment.

FIG. 8 illustrates an exemplary display for prioritized task list as implemented by the platform, language, database, and cloud agnostic third party continuous monitoring module of FIG. 4 in accordance with an exemplary embodiment.

FIG. 9A illustrates an exemplary display for preset combinations as part of machine learning based intuitive dynamic risk evaluation as implemented by the platform, language, database, and cloud agnostic third party continuous monitoring module of FIG. 4 in accordance with an exemplary embodiment.

FIG. 9B illustrates an exemplary display for risk exposure as part of machine learning based intuitive dynamic risk evaluation as implemented by the platform, language, database, and cloud agnostic third party continuous monitoring module of FIG. 4 in accordance with an exemplary embodiment.

FIG. 9C illustrates an exemplary display for variable risk attributes as part of machine learning based intuitive dynamic risk evaluation as implemented by the platform, language, database, and cloud agnostic third party continuous monitoring module of FIG. 4 in accordance with an exemplary embodiment.

FIG. 10 illustrates another exemplary display for dynamic risk evaluation as implemented by the platform, language, database, and cloud agnostic third party continuous monitoring module of FIG. 4 in accordance with an exemplary embodiment.

FIG. 11 illustrates an exemplary flow chart of a process of machine learning based remediation and closure path as implemented by the platform, language, database, and cloud agnostic third party continuous monitoring module of FIG. 4 in accordance with an exemplary embodiment.

FIG. 12 illustrates an exemplary display for supplier research view including attributes and application of Supplier Risk Radar, representing a specific supplier risk vis-à-vis overall risk map of all suppliers in ecosystem as implemented by the platform, language, database, and cloud agnostic third party continuous monitoring module of FIG. 4 integrated with a project tracking system in accordance with an exemplary embodiment.

FIG. 13 illustrates another exemplary display for supplier research detailed view as implemented by the platform, language, database, and cloud agnostic third party continuous monitoring module of FIG. 4 integrated with a project tracking system in accordance with an exemplary embodiment.

FIG. 14 illustrates an exemplary flow chart of a process implemented by the platform, language, database, and cloud agnostic third party continuous monitoring module of FIG. 4 for proactive third party risk monitoring and management in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

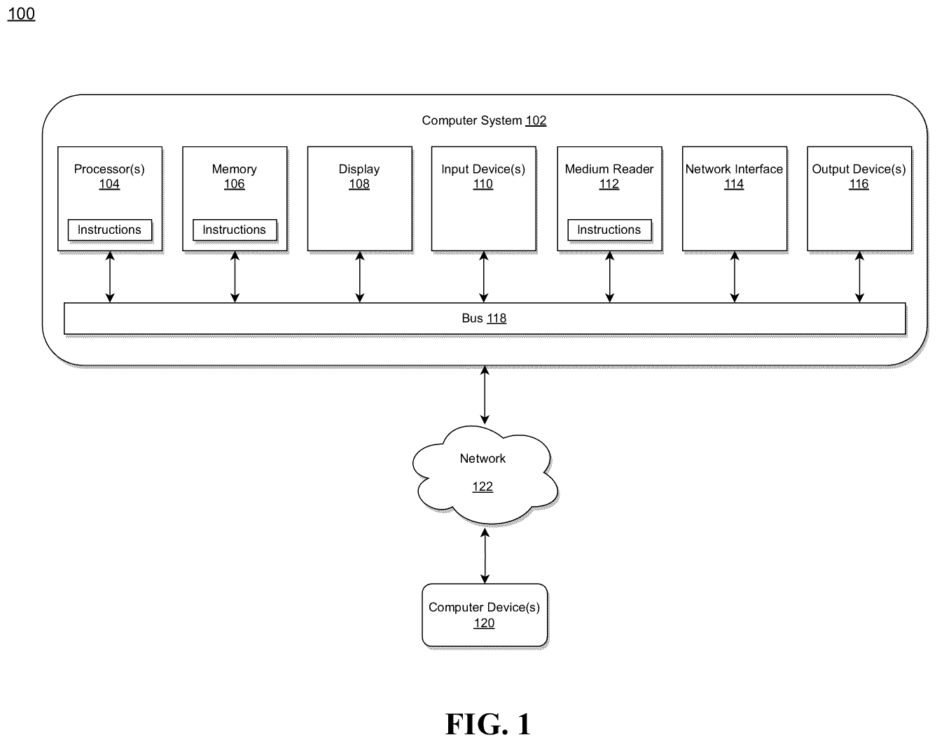

FIG. 1 is an exemplary system 100 for use in implementing a platform, language, database, and cloud agnostic third party continuous monitoring module configured to continuously monitor services provided by third party suppliers (or simply, suppliers) for identifying risks associated with the third party services and provide real time updates and proactively trigger alerts when risks associated with the third party services are detected in accordance with an exemplary embodiment. The system 100 is generally shown and may include a computer system 102, which is generally indicated. Automatic and dynamic natures of the instant disclosures are implemented by the FIGS. 1-14 as described below.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

According to exemplary embodiments, the third party continuous monitoring module may be platform, language, database, and cloud agnostic that may allow for consistent easy orchestration and passing of data through various components to output a desired result regardless of platform, browser, language, database, and cloud environment. Since the disclosed process, according to exemplary embodiments, is platform, language, database, browser, and cloud agnostic, the third party continuous monitoring module may be independently tuned or modified for optimal performance without affecting the configuration or data files. The configuration or data files, according to exemplary embodiments, may be written using JSON, but the disclosure is not limited thereto. For example, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

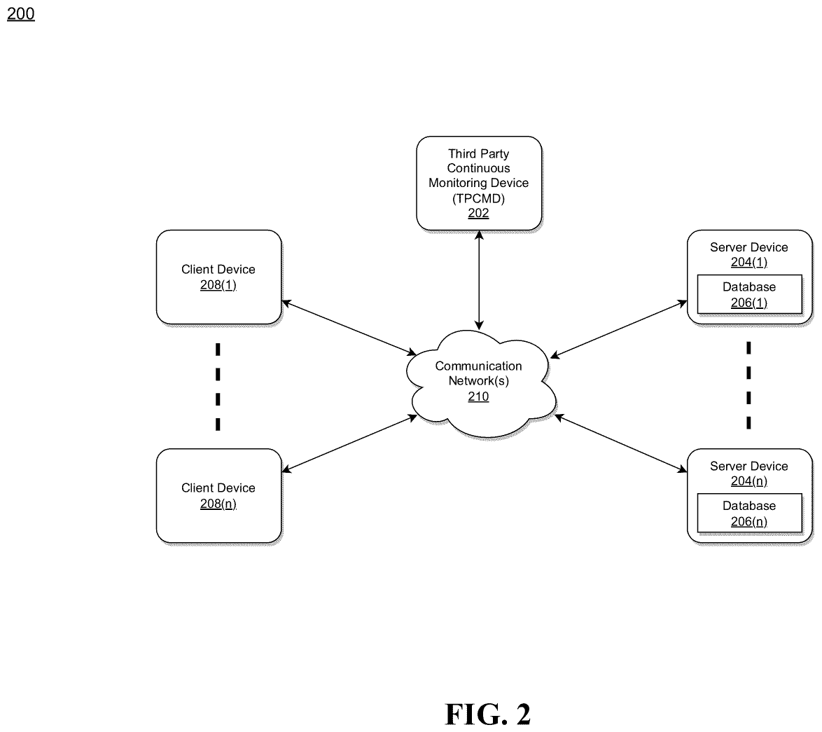

Referring to FIG. 2, a schematic of an exemplary network environment 200 for implementing a language, platform, database, and cloud agnostic third party continuous monitoring device (TPCMD) of the instant disclosure is illustrated.

According to exemplary embodiments, the above-described problems associated with conventional tools may be overcome by implementing an TPCMD 202 as illustrated in FIG. 2 that may be configured for implementing a platform, language, database, and cloud agnostic third party continuous monitoring module configured to continuously monitor services provided by third party suppliers (or simply, suppliers) for identifying risks associated with the third party services and provide real time updates and proactively trigger alerts when risks associated with the third party services are detected, but the disclosure is not limited thereto.

The TPCMD 202 may be the same or similar to the computer system 102 as described with respect to FIG. 1.

The TPCMD 202 may store one or more applications that can include executable instructions that, when executed by the TPCMD 202, cause the TPCMD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the TPCMD 202 itself, may be located in virtual server(s) running in a cloud-based computing environment rather than being tied to one or more specific physical network computing devices. Also, the application(s) may be running in one or more virtual machines (VMs) executing on the TPCMD 202. Additionally, in one or more embodiments of this technology, virtual machine(s) running on the TPCMD 202 may be managed or supervised by a hypervisor.

In the network environment 200 of FIG. 2, the TPCMD 202 is coupled to a plurality of server devices 204(1)-204(n) that hosts a plurality of databases 206(1)-206(n), and also to a plurality of client devices 208(1)-208(n) via communication network(s) 210. A communication interface of the TPCMD 202, such as the network interface 114 of the computer system 102 of FIG. 1, operatively couples and communicates between the TPCMD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the TPCMD 202, the server devices 204(1)-204 (n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The TPCMD 202 may be a standalone device or integrated with one or more other devices or apparatuses, such as one or more of the server devices 204(1)-204(n), for example. In one particular example, the TPCMD 202 may be hosted by one of the server devices 204(1)-204(n), and other arrangements are also possible. Moreover, one or more of the devices of the TPCMD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the TPCMD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the TPCMD 202 that may efficiently provide a platform for implementing a platform, language, database, and cloud agnostic third party continuous monitoring module configured to continuously monitor services provided by third party suppliers (or simply, suppliers) for identifying risks associated with the third party services and provide real time updates and proactively trigger alerts when risks associated with the third party services are detected, but the disclosure is not limited thereto.

The client devices 208(1)-208(n) may run interface applications, such as standard web browsers or standalone client applications, which may provide an interface to communicate with the TPCMD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the TPCMD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the TPCMD 202, the server devices 204(1)-204(n), or the client devices 208(1)-208(n), for example, may be configured to operate as virtual instances on the same physical machine. For example, one or more of the TPCMD 202, the server devices 204(1)-204(n), or the client devices 208(1)-208(n) may operate on the same physical device rather than as separate devices communicating through communication network(s) 210. Additionally, there may be more or fewer TPCMDs 202, server devices 204(1)-204(n), or client devices 208(1)-208(n) than illustrated in FIG. 2. According to exemplary embodiments, the TPCMD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

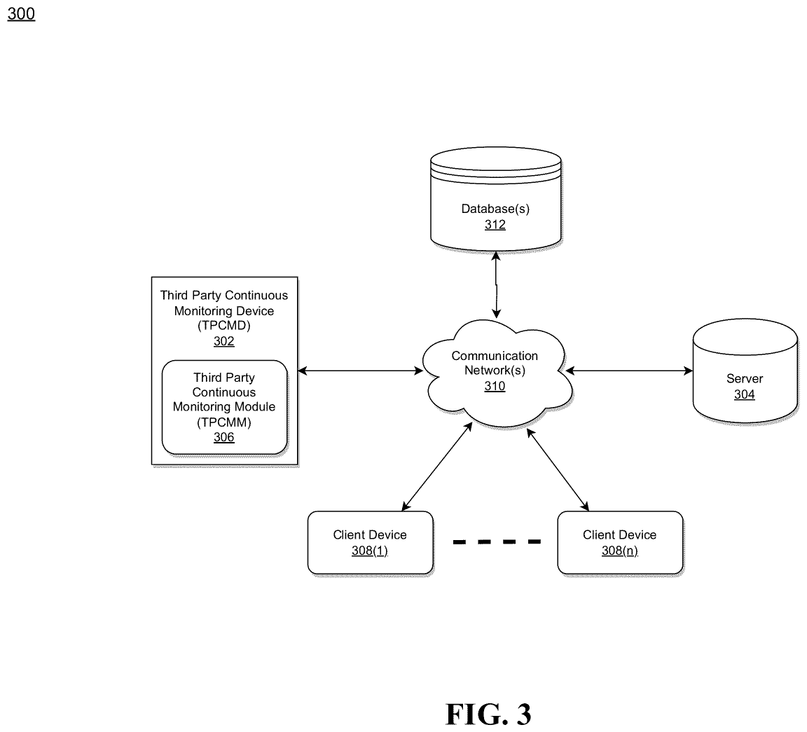

FIG. 3 illustrates a system diagram for implementing a platform, language, and cloud agnostic TPCMD having a platform, language, database, and cloud agnostic third party continuous monitoring module (TPCMM) in accordance with an exemplary embodiment.

As illustrated in FIG. 3, the system 300 may include an TPCMD 302 within which an TPCMM 306 is embedded, a server 304, a database(s) 312, a plurality of client devices 308(1) . . . 308(n), and a communication network 310.

According to exemplary embodiments, the TPCMD 302 including the TPCMM 306 may be connected to the server 304, and the database(s) 312 via the communication network 310. The TPCMD 302 may also be connected to the plurality of client devices 308(1) 308(n) via the communication network 310, but the disclosure is not limited thereto.

According to exemplary embodiment, the TPCMD 302 is described and shown in FIG. 3 as including the TPCMM 306, although it may include other rules, policies, modules, databases, or applications, for example. According to exemplary embodiments, the database(s) 312 may be configured to store ready to use modules written for each Application Programming Interface (API) for all environments. Although only one database is illustrated in FIG. 3, the disclosure is not limited thereto. Any number of desired databases may be utilized for use in the disclosed invention herein. The database(s) may be a mainframe database, a log database that may produce programming for searching, monitoring, and analyzing machine-generated data via a web interface, etc., but the disclosure is not limited thereto.

According to exemplary embodiments, the TPCMM 306 may be configured to receive real-time feed of data from the plurality of client devices 308(1) . . . 308(n) and secondary sources via the communication network 310.

As may be described below, the TPCMM 306 may be configured to: identify base criteria that is already known data about third party suppliers who provide services to an organization; run the base criteria continuously according to a configurable time window to identify suppliers that meet a certain set of the base criteria; identify or map triggers from curated sources (externally sourced or news based platforms) to curate triggers data, that are not yet validated, received from external sources in addition to the base criteria; automatically match the triggers data with corresponding scenario which is a predefined or preconfigured combination of the base criteria and trigger criteria; define risk thresholds for each of the base criteria and the trigger criteria, wherein breaching this combined combination is treated as a positive match for displaying to an analyst for prioritization; implement a validation process to identify critical threat associated with the particular supplier by eliminating false positives from the match; and automatically assign, in response to a positive validation result, a priority to the particular supplier for continuous risk monitoring and management to eliminate or remediate the identified critical threat, but the disclosure is not limited thereto.

The plurality of client devices 308(1) . . . 308(n) are illustrated as being in communication with the TPCMD 302. In this regard, the plurality of client devices 308(1) . . . 308(n) may be “clients” (e.g., customers) of the TPCMD 302 and are described herein as such. Nevertheless, it is to be known and understood that the plurality of client devices 308(1) . . . 308(n) need not necessarily be “clients” of the TPCMD 302, or any entity described in association therewith herein. Any additional or alternative relationship may exist between either or both of the plurality of client devices 308(1) . . . 308(n) and the TPCMD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the TPCMD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The TPCMD 302 may be the same or similar to the TPCMD 202 as described with respect to FIG. 2, including any features or combination of features described with respect thereto.

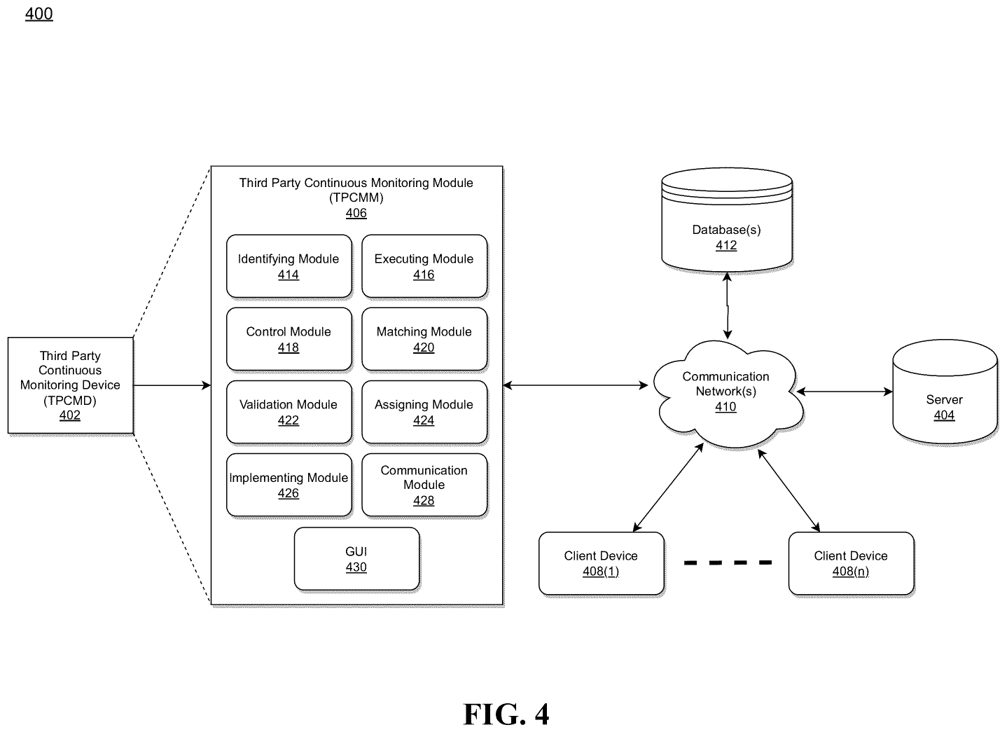

FIG. 4 illustrates a system diagram for implementing a platform, language, database, and cloud agnostic TPCMM of FIG. 3 in accordance with an exemplary embodiment.

According to exemplary embodiments, the system 400 may include a platform, language, database, and cloud agnostic TPCMD 402 within which a platform, language, database, and cloud agnostic TPCMM 406 is embedded, a server 404, database(s) 412, and a communication network 410. According to exemplary embodiments, server 404 may comprise a plurality of servers located centrally or located in different locations, but the disclosure is not limited thereto.

According to exemplary embodiments, the TPCMD 402 including the TPCMM 406 may be connected to the server 404 and the database(s) 412 via the communication network 410. The TPCMD 402 may also be connected to the plurality of client devices 408(1)-408(n) via the communication network 410, but the disclosure is not limited thereto. The TPCMM 406, the server 404, the plurality of client devices 408(1)-408(n), the database(s) 412, the communication network 410 as illustrated in FIG. 4 may be the same or similar to the TPCMM 306, the server 304, the plurality of client devices 308(1)-308(n), the database(s) 312, the communication network 310, respectively, as illustrated in FIG. 3.

According to exemplary embodiments, as illustrated in FIG. 4, the TPCMM 406 may include an identifying module 414, an executing module 416, a control module 418, a matching module 420, a validation module 422, an assigning module 424, an implementing module 426, a communication module 428, and a graphical user interface (GUI) 430. According to exemplary embodiments, interactions and data exchange among these modules included in the TPCMM 406 provide the advantageous effects of the disclosed invention. Functionalities of each module of FIG. 4 may be described in detail below with reference to FIGS. 4-14.

According to exemplary embodiments, each of the identifying module 414, executing module 416, control module 418, matching module 420, validation module 422, assigning module 424, implementing module 426, and the communication module 428 of the TPCMM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

According to exemplary embodiments, each of the identifying module 414, executing module 416, control module 418, matching module 420, validation module 422, assigning module 424, implementing module 426, and the communication module 428 of the TPCMM 406 of FIG. 4 may be implemented by microprocessors or similar, and may be programmed using software (e.g., microcode) to perform various functions discussed herein and may optionally be driven by firmware and/or software.

Alternatively, according to exemplary embodiments, each of the identifying module 414, executing module 416, control module 418, matching module 420, validation module 422, assigning module 424, implementing module 426, and the communication module 428 of the TPCMM 406 of FIG. 4 may be implemented by dedicated hardware, or as a combination of dedicated hardware to perform some functions and a processor (e.g., one or more programmed microprocessors and associated circuitry) to perform other functions.

According to exemplary embodiments, each of the identifying module 414, executing module 416, control module 418, matching module 420, validation module 422, assigning module 424, implementing module 426, and the communication module 428 of the TPCMM 406 of FIG. 4 may be called via corresponding API.

According to exemplary embodiments, the process implemented by the TPCMM 406 may be executed via the communication module 428 and the communication network 410, which may comprise plural networks as described above. For example, in an exemplary embodiment, the various components of the TPCMM 406 may communicate with the server 404, and the database(s) 412 via the communication module 428 and the communication network 410 and the results may be displayed onto a graphical user interface embedded within the TPCMM 406 or withing the client device 408(1)-408(n). Of course, these embodiments are merely exemplary and are not limiting or exhaustive. The database(s) 412 may include the databases included within the private cloud and/or public cloud and the server 404 may include one or more servers within the private cloud and the public cloud.

For example, according to exemplary embodiments, the identifying module 414 may be configured to identify base criteria that is already known data about third party suppliers who provide services to an organization. The known data about third party suppliers may be collected and stored internally during onboarding of the suppliers to the organization in outsourcing such services, but the disclosure is not limited thereto.

According to exemplary embodiments, the identified suppliers may be subjected to continuous monitoring for risk management and mitigation.

According to exemplary embodiments, the executing module 416 may be configured to run the base criteria continuously according to a configurable time window to identify suppliers that meet a certain set of the base criteria. According to exemplary embodiments, the configurable time window may be, daily, hourly, or any other configurable time, but the disclosure is not limited thereto.

According to exemplary embodiments, the control module 418 may be configured to identify or map triggers from curated sources (externally sourced or news based platforms) to curate triggers data, that are not yet validated, received from external sources in addition to the base criteria. The matching module 420 may be configured to automatically match the triggers data with corresponding scenario which is a predefined or preconfigured combination of the base criteria and trigger criteria and define risk thresholds for each of the base criteria and the trigger criteria, wherein breaching this combined combination is treated as a positive match for displaying to an analyst for prioritization. The validation module 422 may be configured to implement a validation process to identify critical threat associated with the particular supplier by eliminating false positives from the match. The assigning module 424 may be configured to automatically assign, in response to a positive validation result, a priority to the particular supplier for continuous risk monitoring and management to eliminate or remediate the identified critical threat.

According to exemplary embodiments, the assigning module 424 may be further configured to automatically assign a priority to the particular supplier for risk monitoring and management based on a corresponding degree of match. For example, multiple triggers match elevates the risk accordingly in a manner such that triggers match for medium priority is greater than the triggers match for low priority, triggers match for high priority is greater than the triggers match for medium priority, and triggers match for critical priority is greater than the triggers match for high priority.

According to exemplary embodiments, the GUI 430 may be further configured to display onto a monitor, utilized by an analyst, preset matches for each risk category; overlay the base criteria with predetermined additional triggers or select new triggers based on current industry risk factors.

According to exemplary embodiments, in implementing the validation process, the assigning module 424 may be further configured to assign a corresponding subject matter expert, based on loading indicators of risk and matched attributes, for manually validating the identified critical threat and subsequent case creation by the validation module 422.

According to exemplary embodiments, in implementing the validation process, the validation module 422 may be further configured to implement an artificial intelligence or rules engine to automatically validate the identified critical threat and subsequent case creation.

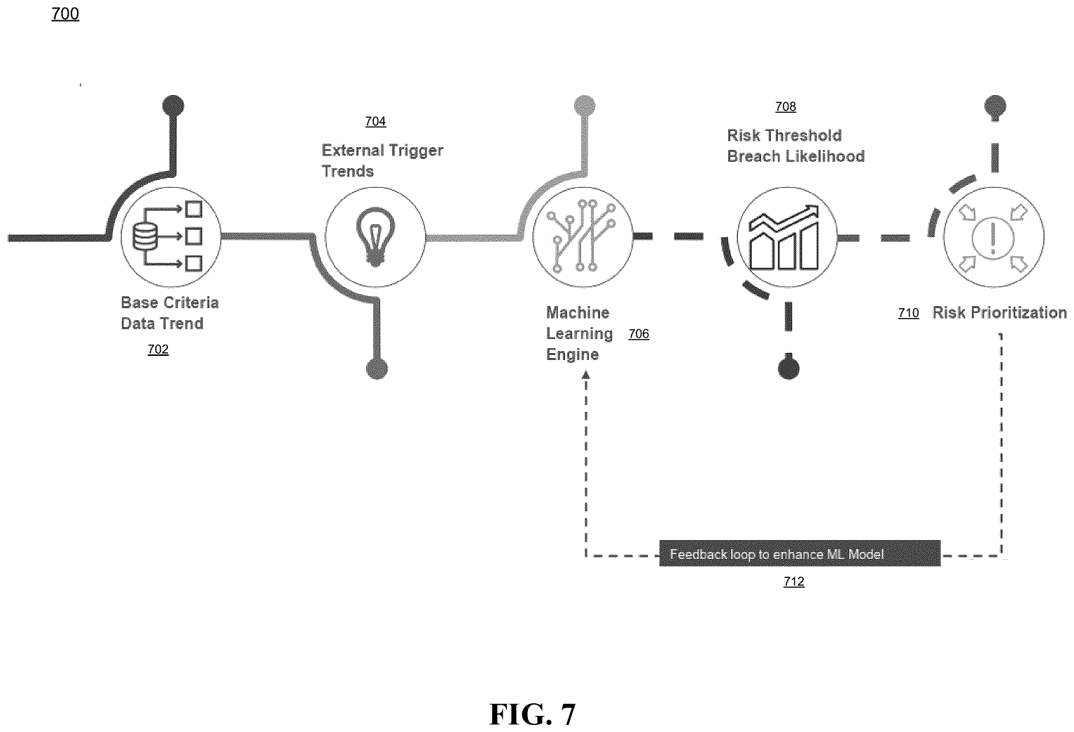

According to exemplary embodiments, the rules engine (i.e., machine learning engine 706 as illustrated in FIG. 7) may implement a machine learning based predictive analytics modeling technique where a machine learning model identifies, matches patterns, and prioritizes suppliers with higher degree or likelihood of risk threshold breach over a future timeline.

According to exemplary embodiments, the machine learning model may generate potential future scenario combinations based on outputs of the rules engine.

Multitude of data sources that exist today from within an organization, as well as curated/processed external data sources, may be leveraged by the TPCMM 406 to enable alerting or triggering of potential risks with the organization's suppliers across multiple outsourcing risk categories including, financial risk, operational risk, business resiliency risk, cyber risk, geopolitical/regulatory risk, ESG (Environmental, Social, and Governance)/reputational risk, etc., but the disclosure is not limited thereto.

The TPCMM 406, according to exemplary embodiments, may be configured to enable proactive third-party risk management by quickly turning supplier data and knowledge of business impact into intelligence and actionable insights thereby resulting the following benefits: understanding where the third party suppliers are most vulnerable; leveraging existing risk attributes within an organization and overlaying it with known external threats to perform impact assessment or validation and proactively remediating or mitigating outsourcing risks; facilitating supplier or partner outreach to inform, track and remediate supplier deficiencies; having an on-demand repository of key supplier risk attributes, including known deficiencies; developing an efficient, sustainable outreach or partner engagement model, etc., but the disclosure is not limited thereto.

According to exemplary embodiments, the base criteria may include risk category based preliminary criteria, e.g., Financial Viability Assessment (FVA) and Inherent Risk Rating (IRR) for financial risk. An FVA is an analysis of a supplier's perceived financial condition and comes in the form of an assessment of financials performed by a designated analyst team within an organization or a designated supplier. IRR may correspond to the risk exposure that exists prior to considering the impact of controls; this may also be referred to as the ‘gross’ level of risk. An organization may set its own parameters and calculation model for rating an outsourcing transaction as “Critical”, “High”, “Medium” or “Low”. According to exemplary embodiments, the base criteria may be dependent on internal data/sources (“Known Knowns”) and acts as a ready source of inventory for suppliers meeting criteria.

According to exemplary embodiments, the additional triggers may include curated/processed intel from external sources and feeds, e.g., an internal news platform (may be referred to as Shared News Analytics Platform (SNAP) hereinafter) that enables data science teams to develop news-based analytics via artificial intelligence. An analyst can map the base criteria to multiple triggers. Moreover, in addition to the base criteria, the TPCMM 406 may create tangible proactive triggers (“Known Unknowns”).

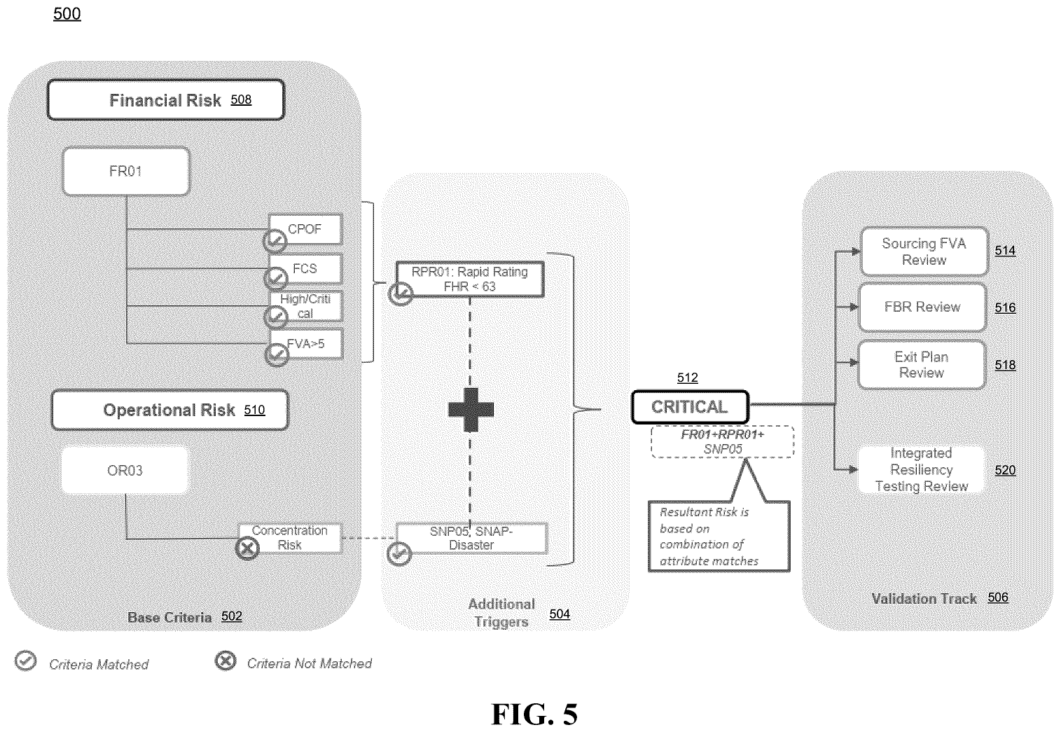

Based on outsourcing risk and trigger criteria match issue validation track(s) (see e.g., validation track 506 as illustrated in FIG. 5) are identified, e.g., review by an internal team or sourcing team etc. False positives are eliminated, and associated cases are closed. Positive validation cases are assigned for remediation. Respective remediation programs are leveraged, e.g., supplier containment, ad hoc control assessment (may be referred to as Supplier Control Assessment (SCA)), etc. The SCA may control assessment of suppliers based on an organization's internal third party risk based methodology.

For example, FIG. 5 illustrates an exemplary architecture 500 for trigger criteria mapping, matching, and prioritization as implemented by the platform, language, database, and cloud agnostic TPCMM 406 of FIG. 4 in accordance with an exemplary embodiment. Cases are tracked or monitored for closure.

FIG. 5 illustrates the base criteria 502, additional triggers 504, and a validation track 506. The base criteria 502 may include financial risk 508 and operational risk 510. An analyst may be presented with preset matches for each risk category. In this example, financial risk FR01 matched for a supplier in the organization's inventory. In this example, the matched criteria may include Critical Point of Failure (CPOF), Firmwide Critical List (FCS), High/Critical, FVA>5.

According to exemplary embodiments, the CPOF may be referred to an asset within a business resiliency plan that, were it not to be performed or were to be disrupted, would materially impact an essential service, causing it to fail and potentially cause harm. The analyst can subsequently overlay base criteria with predetermined additional triggers or select new triggers based on current industry risk factors.

According to exemplary embodiments, the suppliers that meet the organization's FCS criteria. Such criteria is subject to change but may always include factors such as cross-LOB (Line-of-Business) impact, critical activities being performed, firmwide spend and engagement risk. The FCS list may be reviewed and updated annually.

In this example as illustrated in FIG. 5, the analyst added ‘SNP05: SNAP-Disaster’ an “operational risk attribute” to a financial risk category. Also, Financial Health Rating (FHR) is showing as FHR<63. FHR is a rating of an organization's health provided by a vendor.

As illustrated in FIG. 5, based on leading indicators of risk and matched attributes, appropriate subject matter experts or program actions are initiated for validations and subsequent case creation by utilizing the validation track 506. The resultant risk is identified as “critical” 512 based on combination of attribute matches. Accordingly, the following reviews are triggered: sourcing FVA review 514, Firmwide Business Resiliency (FBR) review 516, exit plan review 518, integrated resiliency testing review 520. An FBR team within a firm may be responsible for the firm's business resiliency policy and standard, and the development and implementation of a risk based operating model and supporting tooling that creates direction for resiliency risk management across the Firm that aligns with internal and external expectations.

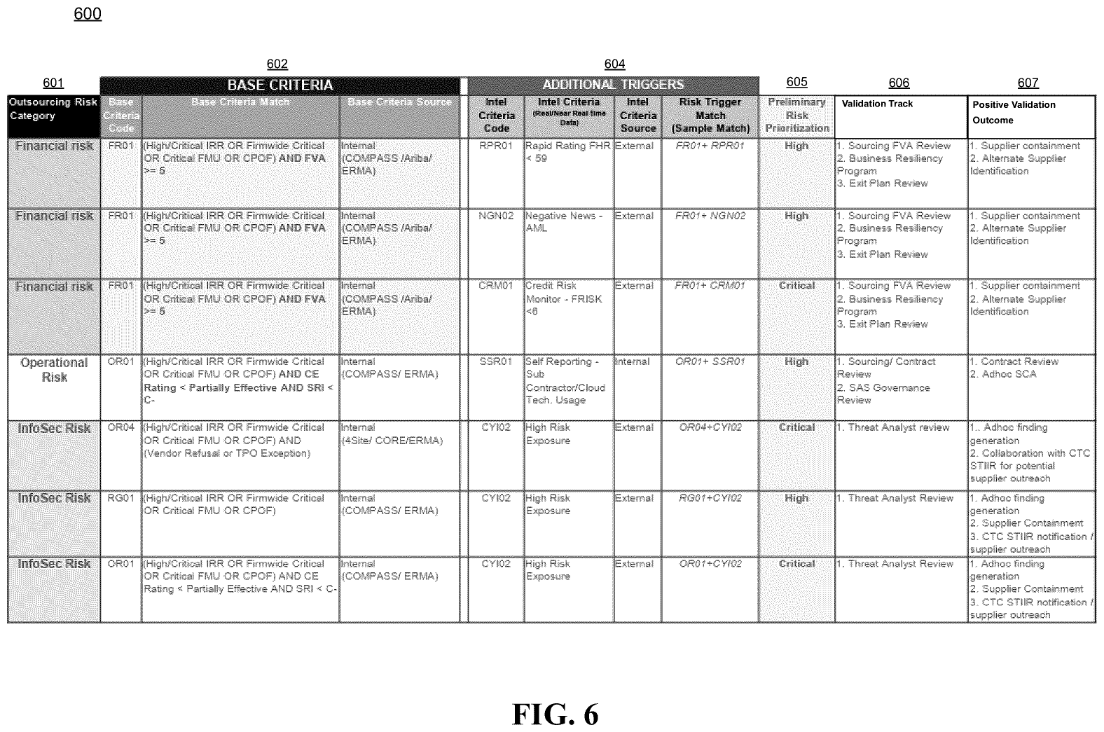

FIG. 6 illustrates an exemplary scenario model sample in table 600 displayed on the GUI 430 as implemented by the platform, language, database, and cloud agnostic TPCMM 406 of FIG. 4 in accordance with an exemplary embodiment. As illustrated in FIG. 6, the table 600 may include a column for outsourcing risk category 601, a column for base criteria 602, a column for additional triggers 604, a column for preliminary risk prioritization 605, validation track 606, and positive validation outcome 607.

FIG. 7 illustrates an exemplary flow chart of a process 700 for machine learning based predictive analytics models for matching and prioritization as implemented by the platform, language, database, and cloud agnostic TPCMM 406 of FIG. 4 in accordance with an exemplary embodiment. Rules engine (i.e., Machine Learning engine 706) incorporates Machine Learning (ML) based Predictive Analytics Modeling. The model identifies, matches patterns and prioritizes suppliers with higher degree/likelihood of risk threshold breach over a future timeline. The model also generates potential future scenario combinations based on outputs of the ML engine 706.

For example, as illustrated in FIG. 7, at the base criteria data trend 702 step of the process 700, model considers base criteria trend over a defined period, e.g., FVA trends over six (6) years and control findings over last three (3) years, but the disclosure is not limited thereto. At the external trigger trends 704 step of the process 700, the model considers corresponding external trigger trends along with number of such events over the same period, e.g., Rapid Rating (Financial Health Trend), cyber incident or vulnerability incidents, news events, etc., but the disclosure is not limited thereto. At the ML engine 706 step of the process 700, machine learning matching/risk prioritization process uses a combination of unsupervised machine learning (e.g., association rules) and statistical models (e.g., Linear regression, probability models). At the risk threshold breach likelihood 708 step of the process 700, the model predicts likelihood of risk threshold breach(es) along with possible time range. For example, potential bankruptcy event by end of fiscal year-High Likelihood; potential data breach within next 60 days-Medium Likelihood. At the risk prioritization 710 step of the process 700, the model prioritizes risk requiring immediate attention based on a combination of elements, e.g., risk severity, likelihood, criticality of service and immediacy of event materializing, etc., but the disclosure is not limited thereto. At step 712 of the process 700, a feedback loop is implemented to enhance the ML model.

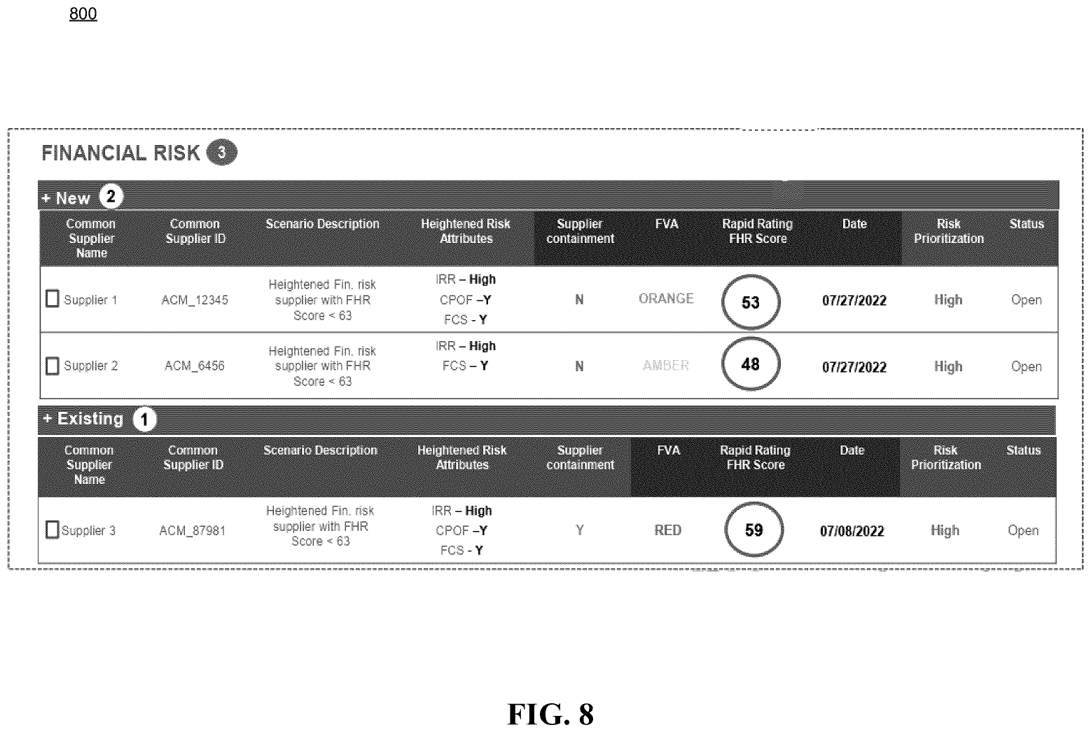

FIG. 8 illustrates an exemplary display 800 as displayed on the GUI 430 for prioritized task list as implemented by the platform, language, database, and cloud agnostic TPCMM 406 of FIG. 4 in accordance with an exemplary embodiment. This display 800 provides a prioritized listing of top issues for a threat analyst ranked based on scenario combination risk and date issue was identified. According to exemplary embodiments, this display 800 may be structured based 1) outsourcing Category Risk and 2) New/Existing-Expandable views which may include a) New issue: Scenario Match Date=Current Date (If no new, issues this may show ‘O’ and may not be expandable) and b) Existing issue: Scenario Match Date<[Current Date+Status< >Closed], sorted by Criticality+latest date match first. As illustrated under the “Rapid Rating FHR Score” tab, key attributes related to breaching risk threshold, matched within scenario, may be highlighted for easy reference e.g., FVA<Amber, IRR Score<63 etc. Clicking on each row should open up Supplier Research View.

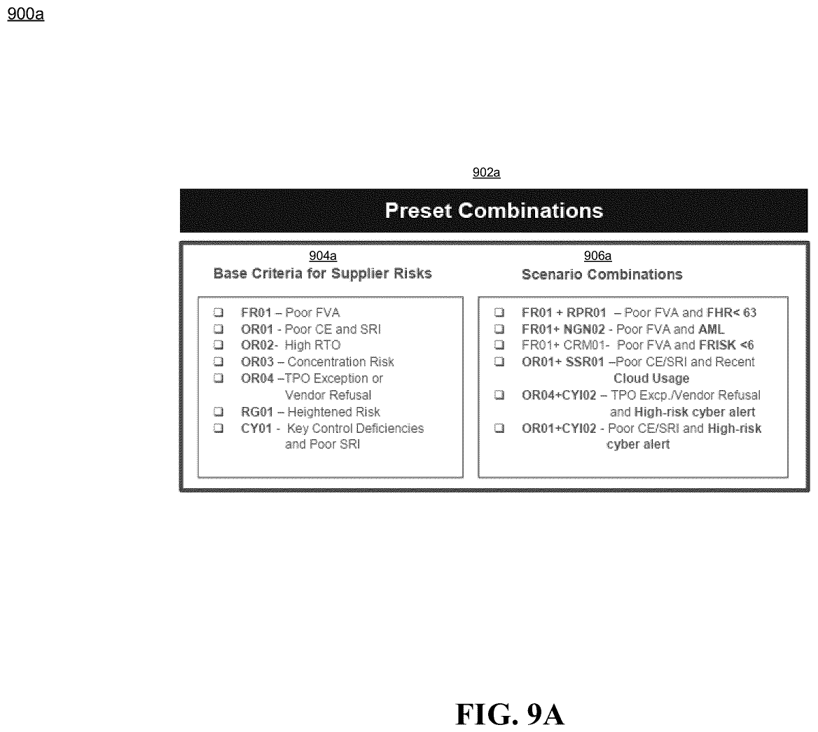

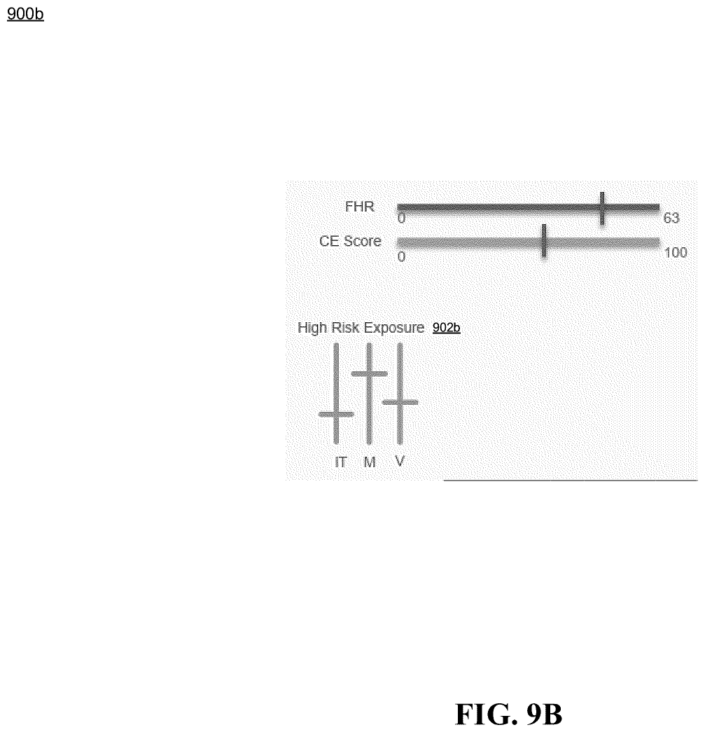

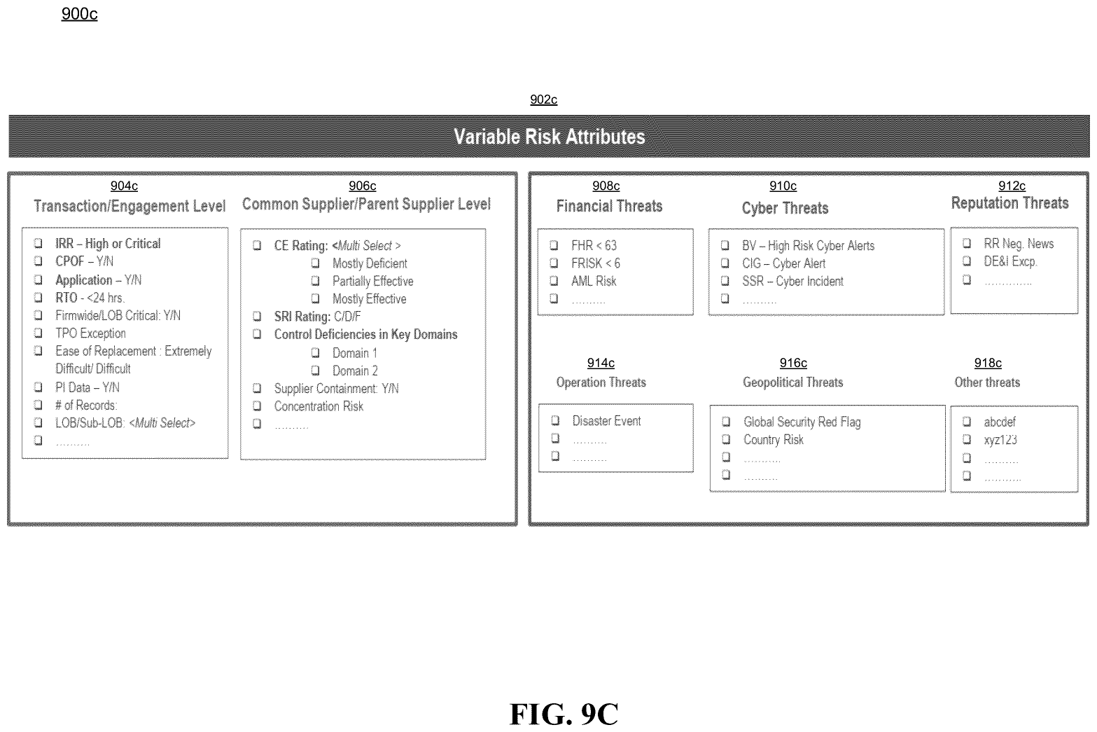

FIG. 9A illustrates an exemplary display 900a as displayed on the GUI 430 for preset combinations as part of machine learning based intuitive dynamic risk evaluation as implemented by the platform, language, database, and cloud agnostic TPCMM 406 of FIG. 4 in accordance with an exemplary embodiment. FIG. 9B illustrates an exemplary display 900b as displayed on the GUI 430 for risk exposure as part of machine learning based intuitive dynamic risk evaluation as implemented by the platform, language, database, and cloud agnostic TPCMM 406 of FIG. 4 in accordance with an exemplary embodiment. FIG. 9C illustrates an exemplary display 900c as displayed on the GUI 430 for variable risk attributes as part of machine learning based intuitive dynamic risk evaluation as implemented by the platform, language, database, and cloud agnostic TPCMM 406 of FIG. 4 in accordance with an exemplary embodiment.

As illustrated in FIGS. 9A-9C, a supplier risk analyst may be presented with capability to overlay additional risk attributes to either preset scenarios combinations or create new scenario combinations. Additionally, the ML model may suggest potential risks to be considered depending on the input criteria or selections.

For example, as illustrated in FIG. 9A, the preset combinations 902a may include base criteria for supplier risks 904a and scenario combinations 906a. An analyst may use existing preset combinations to help identify additional suppliers. For example, the analyst may add Base Criteria CY 01 to Scenario Combination FR01+RPR01. This may help identify critical supplier with Poor FVA+FHR<63 AND Poor SRI (Supplier Risk Index)+Control Deficiencies in Key domains.

As illustrated in FIG. 9B, the display 900b may illustrate high risk exposure 902b. The ML model may present potential risk thresholds to be considered based on the historical data related to associated risk threshold considerations (variable risk threshold). The ML model may also suggest potential new scenario combinations for an analyst to save. As illustrated in FIG. 9B, CE score may represent Control Effectiveness (CE) rating. The evaluation and rating of a supplier's control environment is derived from an assessment of how well the controls are designed relative to the risk of the services provided and the operating effectiveness at mitigating that risk. Rating of Controls may be on a 1 to 5 scale: Effective, Mostly Effective, Partially Effective, Mostly Deficient, and No Controls Reviewed.

As illustrated in FIG. 9C, the display 900c may illustrate variable risk attributes 902c that may include transaction/engagement level 904c, common supplier/parent supplier level 906c, financial threats 908c, cyber threats 910c, reputation threats 912c, operation threats 914c, geopolitical threats 916c and other threats 918c.

According to exemplary embodiments, with reference to FIGS. 9A-13, the following terms may be utilized for ease of discussion.

BV Risk Score may correspond to Blue Voyant Risk Score. An entity level information security/cyber risk score provided by a third party-Blue Voyant.

RF Risk Score may correspond to Recorded Future Risk Score. An entity level information security/cyber risk score provided by a third party-Recorded Future.

CRA may correspond to Control Risk Assessment.

ACA may correspond to Application Control Assessment that focuses on Application controls as part of supplier control assessment.

AP may correspond to Action Plan. SCA/ACA issue/finding disposition method owned by a supplier to remediate operational risk and to address the potential for non-compliance with laws, rules and regulations.

RA may correspond to Risk Accept. A Risk Acceptance (RA) is meant to highlight when a control deficiency or gap will intentionally not be addressed for a period of time (no greater than one year).

Recovery Time Objective (“RTO”) is the amount of time planned for an activity to take the steps necessary to achieve its target recovery operating level.

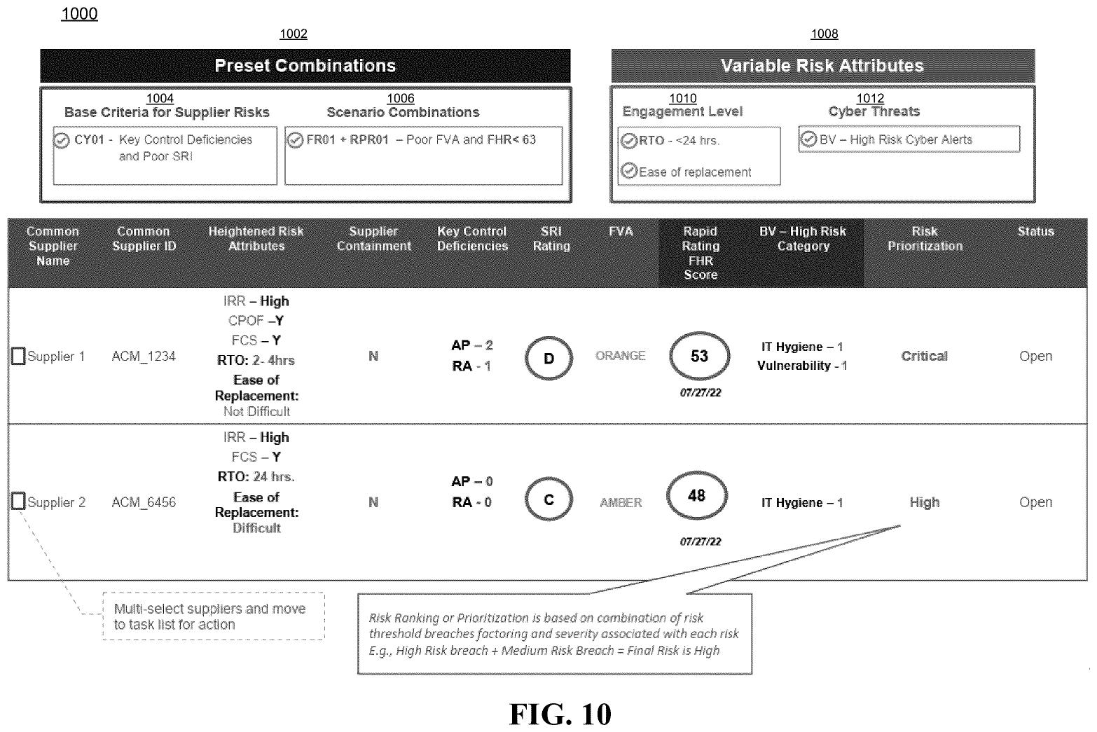

FIG. 10 illustrates another exemplary display 1000 as displayed on the GUI 430 for dynamic risk evaluation as implemented by the platform, language, database, and cloud agnostic TPCMM 406 of FIG. 4 in accordance with an exemplary embodiment. Dynamic risk evaluation selection combinations present a ‘Dynamic listing’ of prioritized view with relevant risk attributes and highlight risk threshold breaches, to help identify and prioritize actions across supplier landscape. As illustrated in FIG. 10, the preset combinations 1002 may include base criteria for supplier risks 1004 and scenario combinations 1006. The variable risk attributes 1008 may include engagement level 1010 and cyber threats 1012. FIG. 10 illustrates multi-select suppliers and move to task list for action. Risk Ranking or Prioritization is based on combination of risk threshold breaches factoring and severity associated with each risk. For example, High Risk breach+Medium Risk Breach=Final Risk is High.

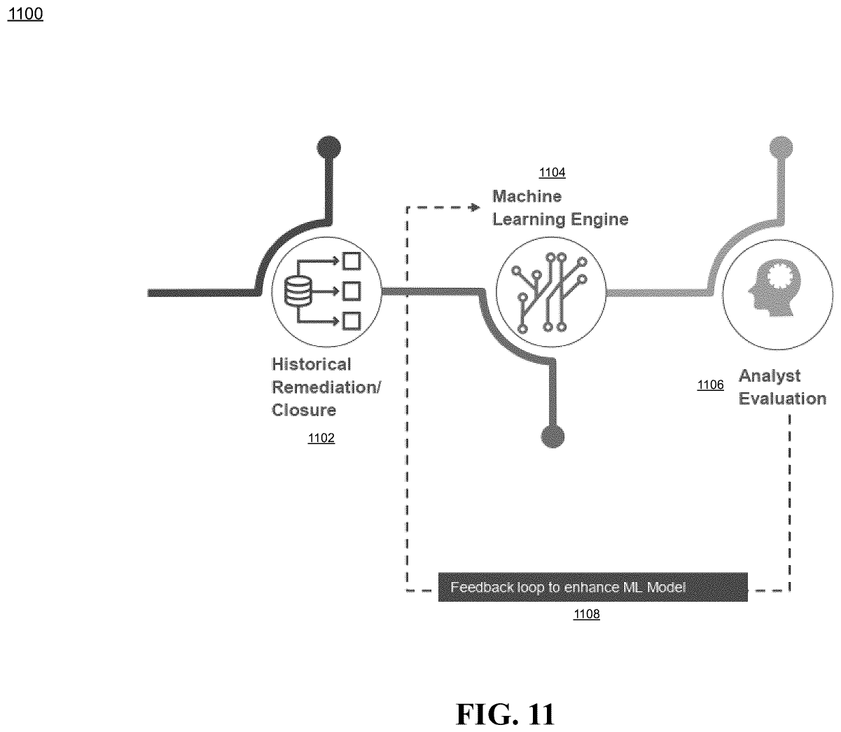

FIG. 11 illustrates an exemplary flow chart of a process 1100 of machine learning based remediation and closure path as implemented by the platform, language, database, and cloud agnostic TPCMM 406 of FIG. 4 in accordance with an exemplary embodiment. As illustrated in FIG. 11, remediation/closure module incorporates ML based remediation paths. The model reviews historical information on remediation and closure for combinations of risk and suggests the best course of closure path from available options. For example, at the historical remediation/closure 1102 step of the process 1100, the model considers historical data on remediation/closure across various scenario combinations/risk threshold breaches. At the ML engine 1104 step of the process 1100, machine learning engines uses unsupervised machine learning (e.g., association rules) to identify/suggest risk remediation/closure paths. At the analyst evaluation 1106 step of the process 1100, an analyst may evaluate the suggested remediation or resolution or closure options and either chooses a suggested path or creates a new path depending on the use case. At step 1108 of the process 1100, a feedback loop is implemented to enhance the ML model.

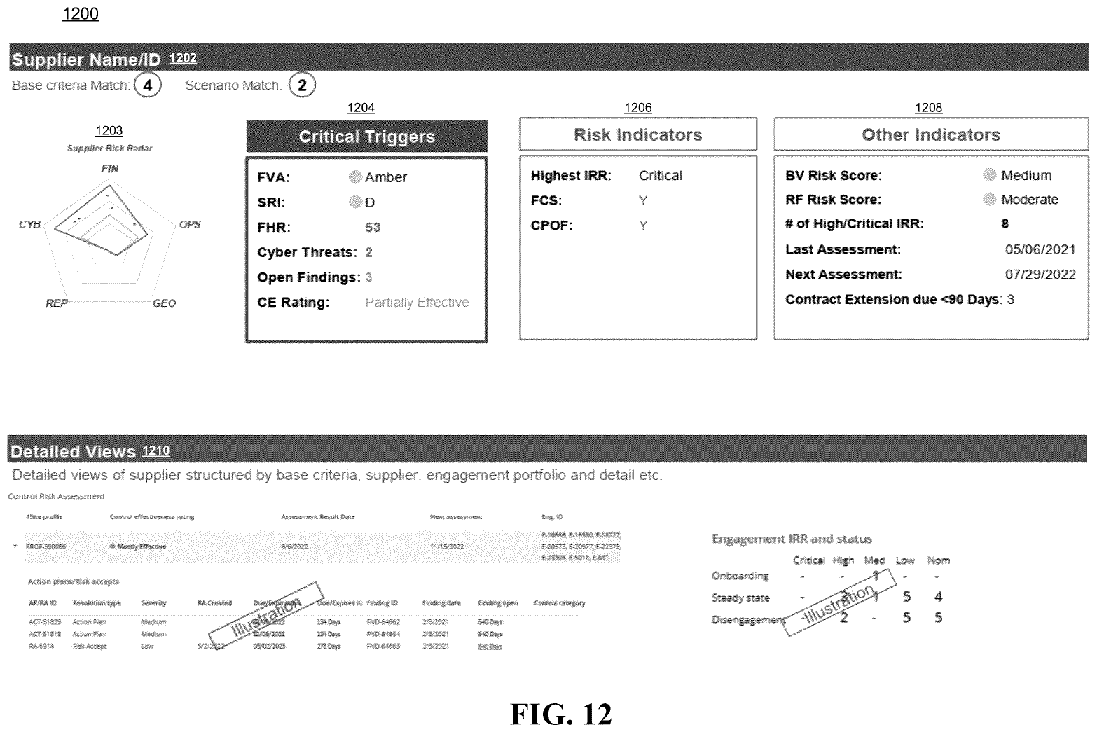

FIG. 12 illustrates an exemplary display 1200 as displayed on the GUI 430 for supplier research view including attributes and application of Supplier Risk Radar, representing a specific supplier risk vis-à-vis overall risk map of all suppliers in ecosystem as implemented by the platform, language, database, and cloud agnostic TPCMM 406 of FIG. 4 integrated with a project tracking system in accordance with an exemplary embodiment. As illustrated in FIG. 12, the exemplary supplier risk radar 1203 displays a pentagon shape where the first corner is represented for financial (FIN) risk, second corner is represented for operational (OPS) risk, third corner is represented for geopolitical (GEO) risk, fourth corner is represented for representation (REP) risk, and the fifth corner is represented for cyber (CYB) risk.

As illustrated in FIG. 12, the supplier research view provides a detailed view for critical triggers, risk indicators and additional information on selected supplier. The first portion of the display 1200 illustrates supplier name/ID 1202 and the second portion of the display 1200 illustrates detailed views 1210. Under the first portion, the critical triggers 1204 illustrates elements from base criteria after ‘AND combination, and elements from Scenario combinations breaching risk thresholds. Under the first portion, the risk indicators 1206 illustrates engagement or supplier level risk attributes providing key insights on potential risk. Under the first portion, the other indicators 1208 illustrates engagement and supplier level attributes which can help provide additional insights. Under the second portion, the detailed views 1210 illustrates detailed views of supplier structured by base criteria, supplier, engagement portfolio and detail etc., but the disclosure is not limited thereto.

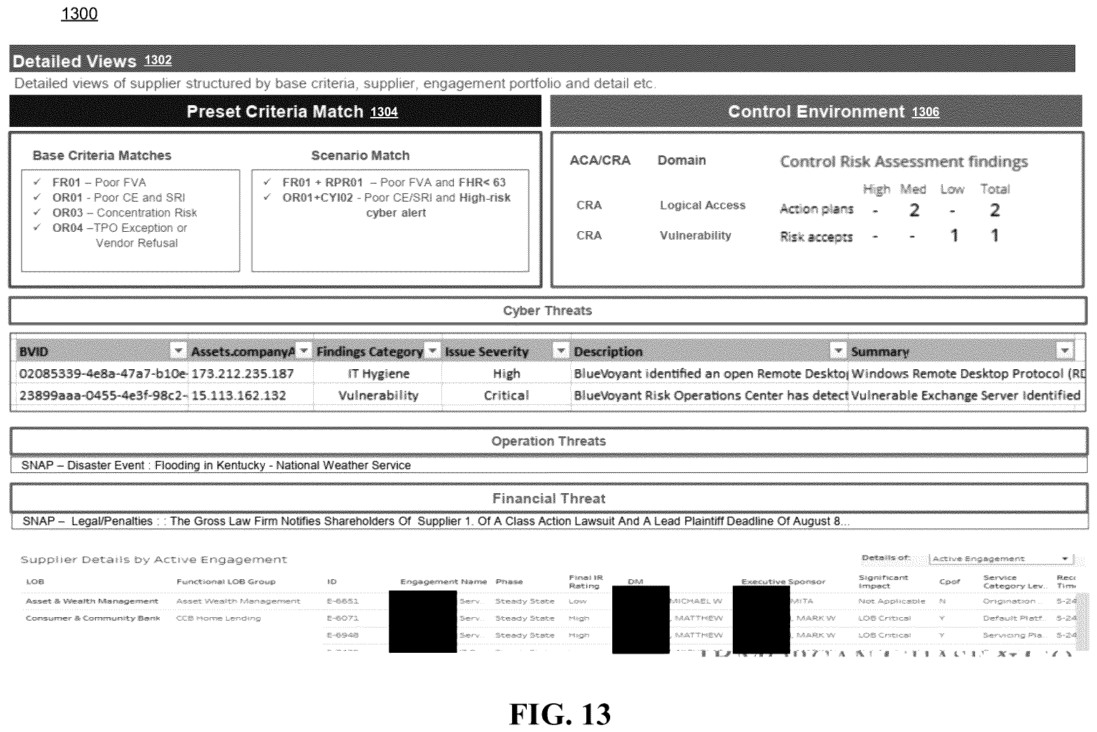

FIG. 13 illustrates another exemplary display 1300 as displayed on the GUI 430 for supplier research detailed view as implemented by the platform, language, database, and cloud agnostic TPCMM 406 of FIG. 4 integrated with a project tracking system in accordance with an exemplary embodiment. The detailed views 1302 illustrates detailed views of supplier structured by base criteria, supplier, engagement portfolio and detail etc., but the disclosure is not limited thereto. The detailed views 1302 may include present criteria match 1304 and control environment 1306, cyber threats, operation threats, and financial threats.

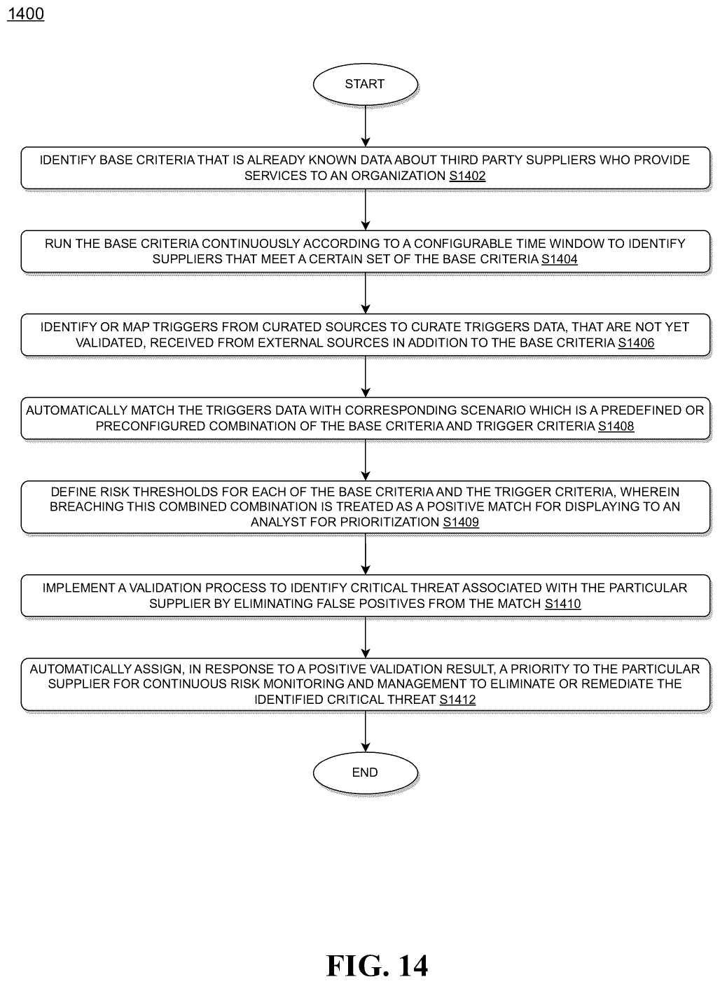

FIG. 14 illustrates an exemplary flow chart of a process 1400 implemented by the platform, language, database, and cloud agnostic TPCMM 4014 of FIG. 4 for continuously monitoring services provided by third party suppliers (or simply, suppliers) for identifying risks associated with the third party services and provide real time updates and proactively triggering alerts when risks associated with the third party services are detected in accordance with an exemplary embodiment. It may be appreciated that the illustrated process 1400 and associated steps may be performed in a different order, with illustrated steps omitted, with additional steps added, or with a combination of reordered, combined, omitted, or additional steps.

As illustrated in FIG. 14, at step S1402, the process 1400 may include identifying base criteria that is already known data about third party suppliers who provide services to an organization.

At step S1404, the process 1400 may include running the base criteria continuously according to a configurable time window to identify suppliers that meet a certain set of the base criteria.

At step S1406, the process 1400 may include identifying or mapping triggers from curated sources (externally sourced or news based platforms) to curate triggers data, that are not yet validated, received from external sources in addition to the base criteria.

At step S1408, the process 1400 may include automatically matching the triggers data with corresponding scenario which is a predefined or preconfigured combination of the base criteria and trigger criteria;

At step S1409, the process 1400 may include defining risk thresholds for each of the base criteria and the trigger criteria, wherein breaching this combined combination is treated as a positive match for displaying to an analyst for prioritization.

At step S1410, the process 1400 may include implementing a validation process to identify critical threat associated with the particular supplier by eliminating false positives from the match.

At step S1412, the process 1400 may include automatically assigning, in response to a positive validation result, a priority to the particular supplier for continuous risk monitoring and management to eliminate or remediate the identified critical threat.

According to exemplary embodiments, the process 1400 may further include: automatically assigning a priority to the particular supplier for risk monitoring and management based on a corresponding degree of match, wherein multiple triggers match elevates the risk accordingly in a manner such that triggers match for medium priority is greater than the triggers match for low priority, triggers match for high priority is greater than the triggers match for medium priority, and triggers match for critical priority is greater than the triggers match for high priority.

According to exemplary embodiments, the process 1400 may further include: collecting the known data about third party suppliers and storing internally during onboarding of the suppliers to the organization in outsourcing such services.

According to exemplary embodiments, the process 1400 may further include: continuously monitoring the identified suppliers for risk management and mitigation.

According to exemplary embodiments, the process 1400 may further include: displaying onto a monitor, utilized by an analyst, preset matches for each risk category; overlaying the base criteria with predetermined additional triggers or selecting new triggers based on current industry risk factors.

According to exemplary embodiments, in implementing the validation process, the process 1400 may further include: assigning a corresponding subject matter expert, based on loading indicators of risk and matched attributes, for manually validating the identified critical threat and subsequent case creation.

According to exemplary embodiments, in implementing the validation process, the process 1400 may further include: implementing an artificial intelligence or rules engine to automatically validate the identified critical threat and subsequent case creation.

According to exemplary embodiments, the process 1400 may further include: implementing, by the artificial intelligence or rules engine, a machine learning based predictive analytics modeling technique where a machine learning model identifies, matches patterns, and prioritizes suppliers with higher degree or likelihood of risk threshold breach over a future timeline.

According to exemplary embodiments, the process 1400 may further include: generating, by the machine learning model, potential future scenario combinations based on outputs of rules engine.

According to exemplary embodiments, the TPCMD 402 may include a memory (e.g., a memory 106 as illustrated in FIG. 1) which may be a non-transitory computer readable medium that may be configured to store instructions for implementing a platform, language, database, and cloud agnostic TPCMM 406 for continuously monitoring services provided by third party suppliers (or simply, suppliers) for identifying risks associated with the third party services and provide real time updates and proactively triggering alerts when risks associated with the third party services are detected as disclosed herein. The TPCMD 402 may also include a medium reader (e.g., a medium reader 112 as illustrated in FIG. 1) which may be configured to read any one or more sets of instructions, e.g., software, from any of the memories described herein. The instructions, when executed by a processor embedded within the TPCMM 406 or within the TPCMD 402, may be used to perform one or more of the methods and processes as described herein. In a particular embodiment, the instructions may reside completely, or at least partially, within the memory 106, the medium reader 112, and/or the processor 104 (see FIG. 1) during execution by the TPCMD 402.

According to exemplary embodiments, the instructions, when executed, may cause a processor embedded within the TPCMM 406 or the TPCMD 402 to perform the following: identifying base criteria that is already known data about third party suppliers who provide services to an organization; running the base criteria continuously according to a configurable time window to identify suppliers that meet a certain set of the base criteria; identifying or mapping triggers from curated sources (externally sourced or news based platforms) to curate triggers data, that are not yet validated, received from external sources in addition to the base criteria; automatically matching the triggers data with corresponding scenario which is a predefined or preconfigured combination of the base criteria and trigger criteria; defining risk thresholds for each of the base criteria and the trigger criteria, wherein breaching this combined combination is treated as a positive match for displaying to an analyst for prioritization; implementing a validation process to identify critical threat associated with the particular supplier by eliminating false positives from the match; and automatically assigning, in response to a positive validation result, a priority to the particular supplier for continuous risk monitoring and management to eliminate or remediate the identified critical threat. According to exemplary embodiments, the processor may be the same or similar to the processor 104 as illustrated in FIG. 1 or the processor embedded within the TPCMD 202, TPCMD 302, TPCMD 402, and TPCMM 406 which is the same or similar to the processor 104.

According to exemplary embodiments, the instructions, when executed, may cause the processor 104 to further perform the following: collecting the known data about third party suppliers and storing internally during onboarding of the suppliers to the organization in outsourcing such services.

According to exemplary embodiments, the instructions, when executed, may cause the processor 104 to further perform the following: continuously monitoring the identified suppliers for risk management and mitigation.

According to exemplary embodiments, the instructions, when executed, may cause the processor 104 to further perform the following: displaying onto a monitor, utilized by an analyst, preset matches for each risk category; overlaying the base criteria with predetermined additional triggers or selecting new triggers based on current industry risk factors.

According to exemplary embodiments, in implementing the validation process, the instructions, when executed, may cause the processor 104 to further perform the following: assigning a corresponding subject matter expert, based on loading indicators of risk and matched attributes, for manually validating the identified critical threat and subsequent case creation.

According to exemplary embodiments, in implementing the validation process, the instructions, when executed, may cause the processor 104 to further perform the following: implementing an artificial intelligence or rules engine to automatically validate the identified critical threat and subsequent case creation.

According to exemplary embodiments, the instructions, when executed, may cause the processor 104 to further perform the following: implementing, by the artificial intelligence or rules engine, a machine learning based predictive analytics modeling technique where a machine learning model identifies, matches patterns, and prioritizes suppliers with higher degree or likelihood of risk threshold breach over a future timeline.

According to exemplary embodiments, the instructions, when executed, may cause the processor 104 to further perform the following: generating, by the machine learning model, potential future scenario combinations based on outputs of rules engine.

According to exemplary embodiments as disclosed above in FIGS. 1-14, technical improvements effected by the instant disclosure may include a platform for implementing a platform, language, database, and cloud agnostic third party continuous monitoring module configured to continuously monitor services provided by third party suppliers (or simply, suppliers) for identifying risks associated with the third party services and provide real time updates and proactively trigger alerts when risks associated with the third party services are detected, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for proactive third party risk monitoring and management by utilizing one or more processors along with allocated memory, the method comprising:
identifying base criteria that is already known data about third party suppliers who provide services to an organization;
running the base criteria continuously according to a configurable time window to identify suppliers that meet a certain set of the base criteria;
identifying or mapping triggers from curated sources to curate triggers data, that are not yet validated, received from external sources in addition to the base criteria;
automatically matching the triggers data with corresponding scenario which is a predefined or preconfigured combination of the base criteria and trigger criteria;
defining risk thresholds for each of the base criteria and the trigger criteria, wherein breaching this combined combination is treated as a positive match for displaying to an analyst for prioritization;
implementing a validation process to identify critical threat associated with the particular supplier by eliminating false positives from the match; and
automatically assigning, in response to a positive validation result, a priority to the particular supplier for continuous risk monitoring and management to eliminate or remediate the identified critical threat.

2. The method according to claim 1, further comprising:
automatically assigning a priority to the particular supplier for risk monitoring and management based on a corresponding degree of match,
wherein multiple triggers match elevates the risk accordingly in a manner such that triggers match for medium priority is greater than the triggers match for low priority, triggers match for high priority is greater than the triggers match for medium priority, and triggers match for critical priority is greater than the triggers match for high priority.

3. The method according to claim 1, further comprising:
collecting the known data about third party suppliers and storing internally during onboarding of the suppliers to the organization in outsourcing such services.

4. The method according to claim 3, further comprising:
continuously monitoring the identified suppliers for risk management and mitigation.

5. The method according to claim 1, further comprising:
displaying onto a monitor, utilized by an analyst, preset matches for each risk category;
overlaying the base criteria with predetermined additional triggers or selecting new triggers based on current industry risk factors.

6. The method according to claim 5, wherein in implementing the validation process, the method further comprising:
assigning a corresponding subject matter expert, based on loading indicators of risk and matched attributes, for manually validating the identified critical threat and subsequent case creation.

7. The method according to claim 5, wherein in implementing the validation process, the method further comprising:
implementing an artificial intelligence or rules engine to automatically validate the identified critical threat and subsequent case creation.

8. The method according to claim 7, further comprising:
implementing, by the artificial intelligence or rules engine, a machine learning based predictive analytics modeling technique where a machine learning model identifies, matches patterns, and prioritizes suppliers with higher degree or likelihood of risk threshold breach over a future timeline.

9. The method according to claim 8, further comprising:
generating, by the machine learning model, potential future scenario combinations based on outputs of rules engine.

10. A system for proactive third party risk monitoring and management, the system comprising:
a processor; and
a memory operatively connected to the processor via a communication interface, the memory storing computer readable instructions, when executed, causes the processor to:
identify base criteria that is already known data about third party suppliers who provide services to an organization;
run the base criteria continuously according to a configurable time window to identify suppliers that meet a certain set of the base criteria;
implement a control assessment process to curate triggers data, that are not yet validated, received from external sources in addition to the base criteria;
automatically match the triggers data with corresponding scenario which is a predefined or preconfigured combination of the base criteria and trigger criteria;
defining risk thresholds for each of the base criteria and the trigger criteria, wherein breaching this combined combination is treated as a positive match for displaying to an analyst for prioritization;
implement a validation process to identify critical threat associated with the particular supplier by eliminating false positives from the match; and
automatically assign, in response to a positive validation result, a priority to the particular supplier for continuous risk monitoring and management to eliminate or remediate the identified critical threat.

11. The system according to claim 10, wherein the processor is further configured to:
automatically assign a priority to the particular supplier for risk monitoring and management based on a corresponding degree of match,
wherein multiple triggers match elevates the risk accordingly in a manner such that triggers match for medium priority is greater than the triggers match for low priority, triggers match for high priority is greater than the triggers match for medium priority, and triggers match for critical priority is greater than the triggers match for high priority.

12. The system according to claim 10, wherein the processor is further configured to:
collect the known data about third party suppliers and store internally during onboarding of the suppliers to the organization in outsourcing such services.

13. The system according to claim 12, wherein the processor is further configured to:
continuously monitor the identified suppliers for risk management and mitigation.

14. The system according to claim 10, wherein the processor is further configured to:
display onto a monitor, utilized by an analyst, preset matches for each risk category;
overlay the base criteria with predetermined additional triggers or selecting new triggers based on current industry risk factors.

15. The system according to claim 14, wherein in implementing the validation process, the processor is further configured to:
assign a corresponding subject matter expert, based on loading indicators of risk and matched attributes, for manually validating the identified critical threat and subsequent case creation.

16. The system according to claim 14, wherein in implementing the validation process, the processor is further configured to:
implement an artificial intelligence or rules engine to automatically validate the identified critical threat and subsequent case creation.

17. The system according to claim 16, wherein the processor is further configured to:
implement, by the artificial intelligence or rules engine, a machine learning based predictive analytics modeling technique where a machine learning model identifies, matches patterns, and prioritizes suppliers with higher degree or likelihood of risk threshold breach over a future timeline.

18. The system according to claim 17, wherein the processor is further configured to:
generate, by the machine learning model, potential future scenario combinations based on outputs of rules engine.

19. A non-transitory computer readable medium configured to store instructions for proactive third party risk monitoring and management, the instructions, when executed, cause a processor to perform the following:
identifying base criteria that is already known data about third party suppliers who provide services to an organization;
running the base criteria continuously according to a configurable time window to identify suppliers that meet a certain set of the base criteria;
identifying or mapping triggers from curated sources to curate triggers data, that are not yet validated, received from external sources in addition to the base criteria;
automatically matching the triggers data with corresponding scenario which is a predefined or preconfigured combination of the base criteria and trigger criteria;
defining risk thresholds for each of the base criteria and the trigger criteria, wherein breaching this combined combination is treated as a positive match for displaying to an analyst for prioritization;
implementing a validation process to identify critical threat associated with the particular supplier by eliminating false positives from the match; and
automatically assigning, in response to a positive validation result, a priority to the particular supplier for continuous risk monitoring and management to eliminate or remediate the identified critical threat.

20. The non-transitory computer readable medium according to claim 19, wherein the instructions, when executed, cause the processor to perform the following:
automatically assign a priority to the particular supplier for risk monitoring and management based on a corresponding degree of match,
wherein multiple triggers match elevates the risk accordingly in a manner such that triggers match for medium priority is greater than the triggers match for low priority, triggers match for high priority is greater than the triggers match for medium priority, and triggers match for critical priority is greater than the triggers match for high priority.
